(19) United States
(12) Patent Application Publication
(10) Pub. No.: US 2015/0032504 A1
(43) Pub. Date: Jan. 29, 2015

(54) INFLUENCE SCORES FOR SOCIAL MEDIA PROFILES

(71) Applicants: Anbazhagan Elango, Bangalore (IN); Mondal Arindam, Bangalore (IN); Chakrabarty Bibhash, Bangalore (IN); Daniel Silvia, Bangalore (IN)

(72) Inventors: Anbazhagan Elango, Bangalore (IN); Mondal Arindam, Bangalore (IN); Chakrabarty Bibhash, Bangalore (IN); Daniel Silvia, Bangalore (IN)

(21) Appl. No.: 14/373,613

(22) PCT Filed: Apr. 23, 2012
(86) PCT No.: PCT/IN2012/000297

§ 371 Date: Sep. 30, 2014

(51) Int. Cl. G06Q 30/02; H04L 29/08

(52) U.S. Cl. CPC G06Q 30/0201; H04L 67/22; H04L 67/306
USPC 705/7.29

(57) ABSTRACT

An influence score can be determined for each of multiple social media profiles. Values can be extracted from the social media profiles and/or data associated with the social media profiles. The values can relate to various metrics, such as messages associated with the social media profiles, attributes of the social media profiles, and network relationships between the social media profiles. An influence score for each social media profile can be determined based on a weighted average of the values.

### BACKGROUND

Social media platforms may allow users to create profiles. Using these profiles, users may send messages to each other or post content for all to see. For example, Twitter® is a social media platform that allows users to send messages consisting of 140 characters or less. These messages are often referred to as “tweets”. Messages from a given Twitter profile may be seen by users that have chosen to subscribe to that profile's feed. Users that have subscribed to a given profile's feed are often referred to as “followers” and it may be said that they follow the given profile. Many other social media platforms exist as well, such as Facebook®, Google+®, and LinkedIn®.

### BRIEF DESCRIPTION OF DRAWINGS

The following detailed description refers to the drawings, wherein:

FIG. 1 illustrates a process to determine an influence score, according to an example.

FIG. 2 illustrates a process to search social media profiles based on a keyword, according to an example.

FIG. 3 illustrates a process to normalize a metric value that may relate to an influence score, according to an example.

FIG. 4 illustrates a process to set a weight for a metric, according to an example.

FIG. 5 illustrates a computer system to determine an influence score, according to an example.

FIG. 6 illustrates a computer-readable medium to determine an influence score, according to an example.

### DETAILED DESCRIPTION

Businesses are often interested in determining effective methods of reaching potential customers and influencing their behavior. With the increasing pervasiveness of computers among many in society as well as the popularity of social media platforms, many businesses could benefit from reaching out to potential customers using social media. Additionally, Identifying and engaging with strong influencers on these social media platforms can be beneficial to businesses.

According to an embodiment, a social influence score can be determined for various profiles on a given social media platform. Based on this score, top influencers can be determined for a given topic over a given time period. The social influence score can be based on various metrics. Example metrics can relate to messages associated with a given profile, attributes associated with a given profile, and network relationships between a given profile and other profiles. The metrics may be assigned different weights based on business rationale, such as market analysis indicating the relative value of each metric, as well as through statistical techniques such as Structural Equation Modeling.

By determining top influencers relating to a given topic or business context, businesses may gain insight into the effectiveness of their own social media marketing campaigns (e.g., the business may have one or more social media profiles sending messages to attempt to influence consumer behavior), and they may identify third party social media players that the business may be able to work with or emulate. In addition, by basing the influence score on various metrics taking into account not just the content of the messages but the reach of the messages based on the profile's network and the like, a more accurate determination of influence may be made. As a result, businesses may improve their advertising and marketing efforts and more effectively influence the behavior of customers and potential customers. Further details of this embodiment and associated advantages, as well as of other embodiments, will be discussed in more detail below with reference to the drawings.

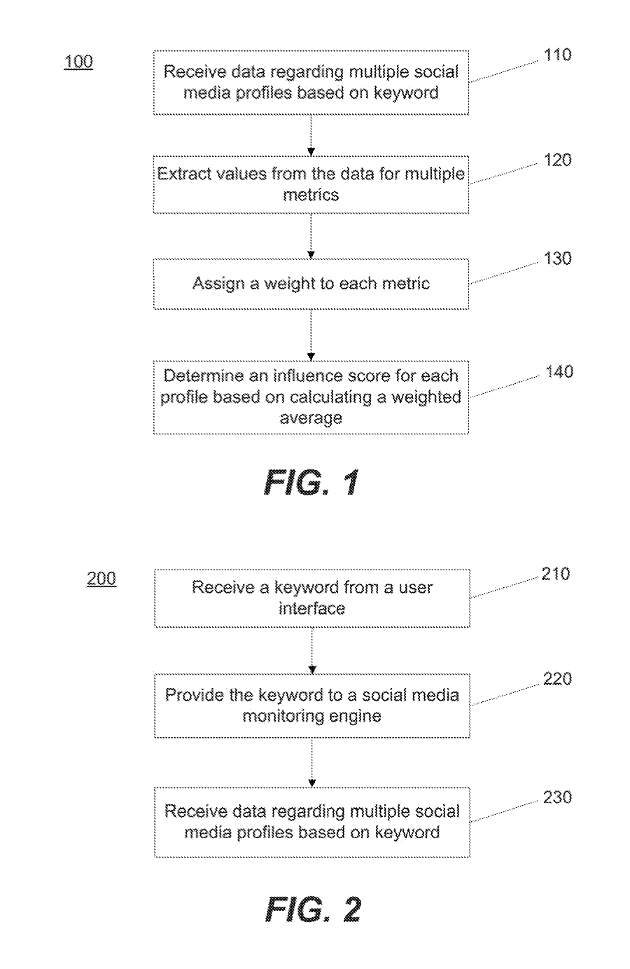

Referring now to the drawings, FIG. 1 is a flowchart illustrating aspects of a method 100 that can be executed by a computing device or system, according to an example. In some examples, system 400 can be used to execute method 100. In addition, method 100 can be executed by a server providing support to a computing device or system. Method 100 may be implemented in the form of executable instructions stored on a machine-readable medium or in the form of electronic circuitry. A processor, a machine-readable storage medium, other control logic, or a combination thereof can be used to execute method 100.

Method 100 can be implemented to determine an influence score of one or more social media profiles. The social media profiles may be profiles of users associated with a social media platform. The social media platform may enable the sharing of information, messages, photos, videos, or the like. For example, the social media platform may be Twitter®, Facebook®, Google+®, or LinkedIn®.

Method 100 can begin at 110 where data regarding multiple social media profiles may be received. The data can be the result of a search of social media profiles and associated data from a single social media platform, such as Twitter®. In one example, as discussed below with reference to FIG. 2, a social media monitoring engine such as Radian6 may be used to perform the search. Additional data regarding the profiles that is not provided by the social media monitoring engine may be obtained from the social media platform itself. For example, an application programming interface (API) for the social media platform may be used to request the data, such as the Twitter API.

The search can be performed based on one or more keywords or a combination of keywords and Boolean operators. The keywords can define or relate to a particular topic or business context. For example, a user, such as a business, may be interested in determining the top influencers in the topic area of music, in which case “music” may be a keyword. More specifically, the user may be interested in the top influencers in the topic area of country music, in which case “country music” may be a keyword. In another example, the user may be interested in the topic area/business context of security aspects of cloud computing, in which case “cloud AND security”, or the like may be the keyword combination. Additionally, the search can be performed based on a time period. For example, the search could be limited to profiles having on-topic messages that were sent during the specified time period. Data regarding social media profiles having profile information, messages, or the like related to the keyword(s) and/or the time period may be provided to method 100.

The data regarding the social media profiles may include various information. Generally, the data may include information regarding the messages sent from the profile, information related to the profile, and information regarding the profile's network. The content and type of data may be based on the nature of the social media platform that the profile comes from. Additionally, the content and type of data may depend on the type of social media monitoring engine used, as different engines may provide different data.

At 120, values may be extracted from the data for each social media profile. The values may relate to a first, second, and third category of metrics. The first category of metrics may relate to messages associated with the social media profile. The second category of metrics may relate to attributes of each social media profile. The third category of metrics may relate to network relationships between each social media profile.

Example metrics for each category are described below with reference to a twitter profile. The “author” referred to below is the user associated with the twitter profile (or owner of the twitter profile). Followers are those users that subscribe to the message feed of the author. Messages sent by the author appear in the timeline of each follower's account. An @mention is a type of message that explicitly mentions another twitter author in a tweet. This sends a notification to the mentioned author as well as causes the @mention to be visible on the author's message feed, which thus makes it viewable by the author's followers on their timelines. Retweets are a message from an author in which the author sends another author's tweet. Hash tags are a technique of categorizing a tweet by placing a hash tag (i.e., #) before the topic word. Thus, if an author wrote a tweet relating to cloud computing, the author could put a hash tag in front of the search term “cloud” as follows: “#cloud”. This enables other users to more accurately search for tweets relevant to a certain topic. Other metrics beyond those shown below may be used as well. Additionally, some of the metrics may change if a different social media platform were used, such as Facebook®.

The first category of metrics may relate to on-topic tweets associated with a twitter profile. In one example, this category can be divided up into five basic measures: engagement gained, engagement done, on-topic activity, on-topic reach, and content value. Example metrics are described below with respect to each measure.

Engagement Gained
1. @mentions gained: The count of tweets that mentions the author.
2. @mentions gained—Unique authors: The number unique profiles authoring tweets that mention the author.
3. Retweets gained: The number of retweets gained by the author.
4. Retweets gained—Unique authors: The number of unique profiles retweeting an author's tweets.
5. Unique tweets retweeted: The number of unique tweets of the author that were retweeted.
6. Retweets h-index: If an author has at least x tweets, each of which is retweeted at least x times, the highest possible value of x is the retweets h-index.
7. Favorites gained: The number of times tweets of the author were “favorited” (indicated as a favorite) by other users.

Engagement Done
1. @mentions done: The number of tweets by the author containing an @mention.
2. @mentions done—Unique authors: The number of unique profiles mentioned by the author.
3. Retweets done: The number of retweets done by the author.
4. Retweets done—Unique authors: The number of unique profiles whose tweets were retweeted by the author.

On-Topic Activity
1. On-topic tweets: The total count of on-topic tweets.
2. Number of active days: The number of days the author tweeted on the topic.
3. Topic focus %: The proportion of total tweets by the author that were on-topic.

On-Topic Reach
1. Direct impressions: The number of users on whose timeline the tweet is directly placed (based on the number of followers of the author).
2. Derived impressions: The number of users on whose timeline the tweet is indirectly placed, such as via retweets and @mentions.

Content Value
1. Tweets with URL: The number of tweets containing a URL (Uniform Resource Locator).
2. Tweets with hashtags: The number of tweets containing hash tags.

The second category of metrics may include profile information associated with the twitter profile. Example metrics are described below.
1. Profile URL declared: Is there a URL associated with the profile. A profile URL is a URL that points to a webpage associated with the author. For example, the webpage could be the author's personal home page, a website for the author's business, etc. This metric may take the value of 1 if a profile URL is declared and 0 if not.
2. Following: The number of people that the author is following.
3. Followers: The number of people that are following the author.
4. Lists—Member: The number of lists that the author is a member of. A list in Twitter® can be created by any user and can include a list of twitter profiles associated with a particular topic or context. The presence of the author on multiple lists can indicate popularity and influence of the author.
5. Lists—Subscribed: The number of lists that the author is subscribed to. By being subscribed to a list, the subscriber can receive tweets from the members of the list.
6. Updates done: The total number of tweets sent from the profile over the life of the profile.

The third category of metrics may include network information related to the twitter profile. The relevant network may be smaller than the entire twitter network. For example, the network may relate only to twitter profiles connected to the given twitter profile in accordance with some degree of closeness. For example, followers, @mentions, and retweets may be considered when determining the network associated with a twitter profile. Example metrics are described below. These metrics may be based on graph theory related to discrete mathematics, where each twitter profile may represent a node in the network. In one example, a tool called NodeXL, which is an add-on tool for Microsoft Excel, may be used to compute the network metrics.
1. Betweenness centrality: This metric indicates whether a particular twitter profile is essential for some other nodes to maintain a relation to the network. In other words, it indicates how many other profiles are connected solely through the given twitter profile.
2. Closeness centrality: This metric indicates the average geodesic distance to other profiles. The geodesic distance is the shortest line between two points. Thus, this metric indicates how close a given twitter profile is to other profiles.
3. Eigenvector centrality: This metric indicates a level of popularity of twitter profiles to which the given twitter profile is directly connected. In other words, it indicates whether profiles that the given profile is adjacent to are adjacent to a large number of other profiles.
4. Clustering coefficient: This metric indicates a level of connectedness and clustering among profiles in a given twitter profile's network. For example, it indicates whether a given profile's connected profiles are also connected to each other, thus making a cluster of connections. This can indicate how tight-knit a profile's network is.

Any combination of metrics as described above, or others not illustrated, may be used to measure social influence of a given twitter profile. The values for each metric may be extracted from the data according to various techniques. For example, the data may be in the form of a spreadsheet, exported from a social media monitoring engine (e.g., Radian6). Values for each metric may thus be determined by referring to the appropriate field(s) in the spreadsheet. For instance, a macro may be programmed in Microsoft Excel to generate metric values for each twitter profile based on the spreadsheet data. As mentioned previously, the macro could leverage a tool such as NodeXL to generate the network graph and extract the network metric values. The values for some metrics may also be extracted using the API of the social media platform.

At 130, a weight may be assigned to each metric. The weight may represent a relative importance of the metric to the overall social influence score. The weight for each metric may be determined and assigned using various techniques. For example, the weight may be determined based on research and analysis of the market and the social media platform. For instance, the particular business segment, context, or topic being considered may influence the importance of certain metrics. Similarly, the nature of the social media platform may influence the importance of certain metrics. The weight may also be determined using a statistical technique, such as Structural Equation Modeling. Additionally, the weight may be determined by a user and set using a user interface. The weight may be determined and set prior to executing method 100. In such a case, assigning the weight to each metric may merely involve applying the predetermined weight to the metric. Alternatively, one or more weights may be determined and assigned during operation of method 100. In such a case, the weights may be set using a user interface or using an automated technique, such as via machine readable instructions employing Structural Equation Modeling.

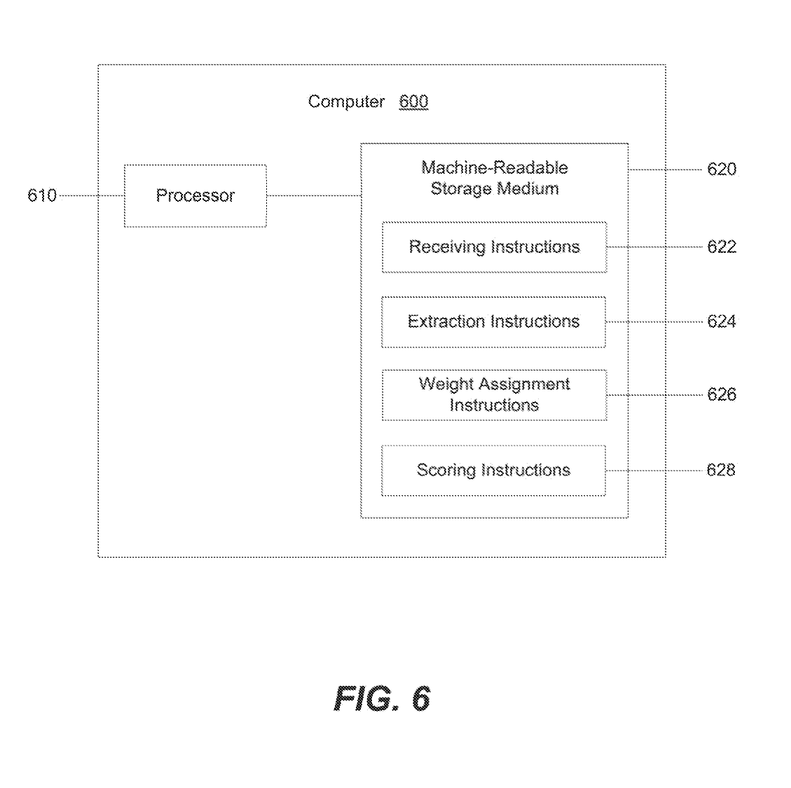

Structural Equation Modeling is a technique that can estimate causal relations using a combination of statistical data and certain assumptions. A metric category may be considered a latent variable if it is not possible to measure it directly, for example, because it is hypothetical or unobserved. A combination of metrics may be used to determine the representative latent variable. The technique is based on the hypothesis that a representative latent variable (e.g., Engagement done) may be explained by a linear combination of variables. For example, “Engagement done” may be modeled as a linear combination of four variables: @mentions done, @mentions done—Unique authors, Retweets done, and Retweets done—Unique authors. The weights or coefficients for each variable can be determined based on statistical importance and fulfillment of certain criterions for the model. The model created by this linear equation structure may be used for multi-level allocation of weights for each metric. For example, as described below with respect to FIG. 6, categorical weights can be determined for a group of metrics. For instance, a categorical weight may be determined for a category of “Engagement done” which can include the four metrics indicated above. Accuracy of the model can be improved with a large input data set (e.g., multiple profiles and associated data) that is free from missing values. In one example, a software tool or procedure may be used to perform the structural equation modeling, such as PROC CALIS in Statistical Analysis System (SAS).

At 140, an influence score may be determined for each social media profile. The score may be determined by calculating a weighted average of the metric values for each profile. The weighted average may be determined using the weights assigned at 130. Accordingly, an influence score directed to the particular topic or business context originally searched may be determined for multiple social media profiles on a social media platform.

FIG. 2 is a flowchart illustrating aspects of a method 200 that can be executed by a computing device or system, according to an example. Method 200 can be used to search social media profiles based on one or more keywords. At 210, a keyword can be received via a user interface. The user interface may be resident on the device or system executing method 200 or it can be on a remote computer, such as on a client device connecting to a server. The keywords can relate to a topic, business context, or the like, as described above. At 220, the keyword can be provided to a social media monitoring engine. The social media monitoring engine can be resident on the device or system executing method 200 or it can be hosted on another computer. In one example, the social media monitoring engine may be a third party system, such as Radian6. The social media engine can execute a search of the specified social media platform and obtain data regarding social media profiles that are relevant to the keyword. Accordingly, at 230, this data can be received. This data may then be used in a process, such as depicted in FIG. 1, to determine an influence score of the identified social media profiles. Additional data regarding the profiles that is not provided by the social media monitoring engine may be obtained from the social media platform itself. For example, an application programming interface (API) for the social media platform may be used to request the data

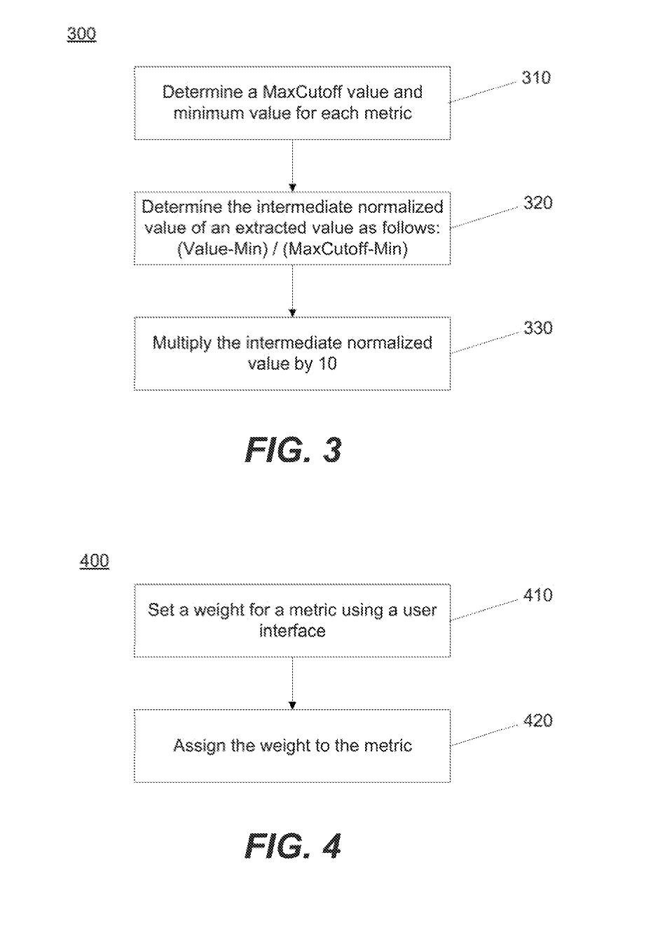

FIG. 3 is a flowchart illustrating aspects of a method 300 that can be executed by a computing device or system, according to an example. Method 300 can be used to normalize metric values. For example, method 300 may be used to normalize the extracted values from block 120 of method 100. At 310, a MaxCutoff value and minimum value can be determined for each metric (over all of the social media profiles). The MaxCutoff value can be a value in a certain high percentile of all of the values for a given metric. For instance, the MaxCutoff value can be the maximum value (the 100^{th} percentile), a value in the 98^{th} percentile, or the like. It can be helpful to use a percentile lower than the 100^{th} percentile to exclude outlying values. At 320, the intermediate normalized value of a given extracted value may be determined by subtracting the minimum value from the value, and dividing the result by the result of subtracting the minimum value from the MaxCutoff value. At 330, the normalized value can be determined by multiplying the intermediate normalized value by 10. In some examples, the normalized values can be subject to a maximum value of ten, such that anything higher is changed to ten. Thus, the score can range between zero and ten, for example.

FIG. 4 is a flowchart illustrating aspects of a method 400 that can be executed by a computing device or system, according to an example. Method 400 can be used to set a weight for a metric via a user interface. For example, method 400 can be used to set weights for one or more metrics in method 100. At 410, a user can set a weight for a metric using a user interface. The user interface can be a graphical user interface. The user interface can be resident on the same computing device or system that executes method 100 or it can be resident on a different computing device or system. The user interface can be part of an application, such as a main application that implements method 100 or a client application that interface with the main application. The user interface can also be implemented via a web browser. The user may be an administrator of the system and may set the weights using the same computer system executing method 100. Alternatively, the user may be a user implementing the system remotely from another device. At 420, the weight set via the user interface can be assigned to the appropriate metric. Assigning the weight to a metric can include storing an association between the weight and the metric. For instance, assigning the weight can be accomplished by modifying a variable in memory.

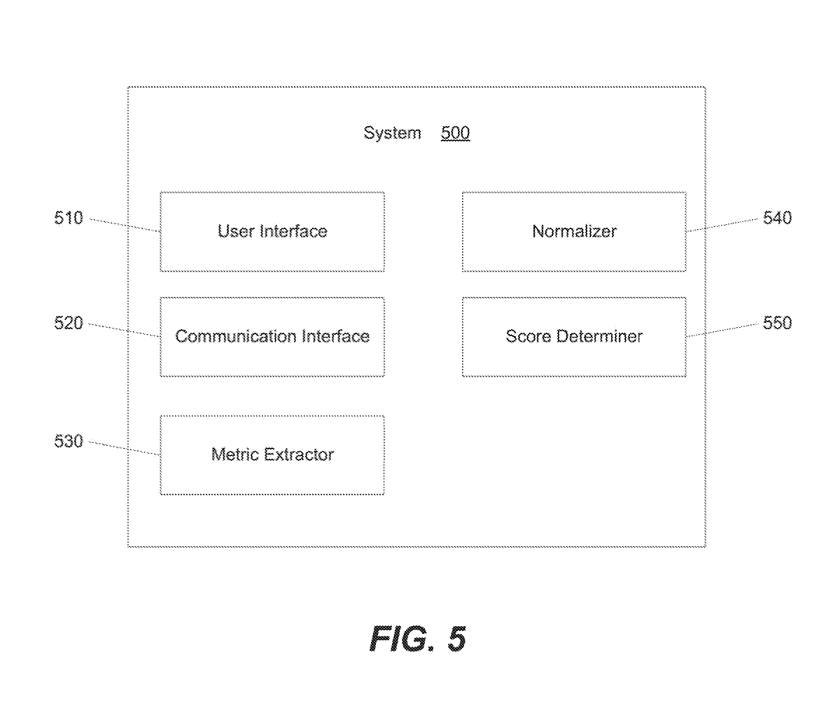

FIG. 5 illustrates a computer system configured to determine an influence score, according to an example. System 500 can be any of various computers or computing devices. For example, system 500 can be a desktop computer, workstation computer, server computer, laptop computer, tablet computer, smart phone, or the like. Although all of the components are shown together in FIG. 5, system 500 can include multiple computers and different components can be resident on different parts of the system. System 500 can be used to implement methods 100, 200, 300, and 400.

System 500 can include a user interface 510. User interface 510 can initiate a search of social media profiles, such as twitter profiles, based on a keyword and/or a time period. User interface 510 can include hardware components and software components. For example, user interface 510 can include an input component, such as a keyboard, mouse, or touch-sensitive surface, etc., and an output component, such as a display, speakers, etc. User interface 510 can also include a graphical user interface.

System 500 can include a communication interface 520. Communication interface 520 can be used to transmit and receive data to and from other computers. For example, communication interface 520 can receive a list of social media profiles and associated data relevant to the keyword and/or time period. Communication interface 520 may include an Ethernet connection or other direct connection to a network, such as an intranet or the Internet. Communication interface 520 may also include, for example, a transmitter that may convert electronic signals to radio frequency (RF) signals and/or a receiver that may convert RF signals to electronic signals. Alternatively, communication interface 520 may include a transceiver to perform functions of both the transmitter and receiver. Communication interface 520 may further include or connect to an antenna assembly to transmit and receive the RF signals over the air. Communication interface 520 may communicate with a network, such as a wireless network, a cellular network, a local area network, a wide area network, a telephone network, an intranet, the Internet, or a combination thereof.

System 500 can include a metric extractor 530, a normalizer 540, and a score determiner 550. These components can be implemented using a combination of hardware, software, firmware, or the like, including a machine-readable medium storing machine-executable instructions and a processor or controller. Metric extractor 530 can identify values of content metrics, profile metrics, and network metrics for each social media profile in the list of social media profiles. The metrics may be similar to the metrics described previously with respect to method 100. Normalizer 540 can normalize the values of the content metrics, profile metrics, and network metrics. Normalizer 540 can normalize the values according to various techniques, such as that described with respect to FIG. 3. Score determiner 550 can determine an influence score for each social media profile. The influence score can be determined by calculating a weighted average of the normalized values associated with each social media profile. System 500 can store weights in association with the various metrics for calculating the weighted average. The weights may be determined and set in various ways, as described above with respect to methods 100 and 400.

FIG. 6 is a block diagram illustrating aspects of a computer 600 including a machine-readable storage medium 620 encoded with instructions, according to an example. Computer 600 may be any of a variety of computing devices, such as a workstation computer, a desktop computer, a laptop computer, a tablet or slate computer, a server computer, or a smart phone, among others.

Processor 610 may be at least one central processing unit (CPU), at least one semiconductor-based microprocessor, other hardware devices or processing elements suitable to retrieve and execute instructions stored in machine-readable storage medium 620, or combinations thereof. Processor 610 can include single or multiple cores on a chip, multiple cores across multiple chips, multiple cores across multiple devices, or combinations thereof. Processor 610 may fetch, decode, and execute instructions 622, 624, 626, 628, among others, to implement various processing. As an alternative or in addition to retrieving and executing instructions, processor 610 may include at least one integrated circuit (IC), other control logic, other electronic circuits, or combinations thereof that include a number of electronic components for performing the functionality of instructions 622, 624, 626, 628. Accordingly, processor 610 may be implemented across multiple processing units and instructions 622, 624, 626, 628 may be implemented by different processing units in different areas of computer 600.

Machine-readable storage medium 620 may be any electronic, magnetic, optical, or other physical storage device that contains or stores executable instructions. Thus, the machine-readable storage medium may comprise, for example, various Random Access Memory (RAM), Read Only Memory (ROM), flash memory, and combinations thereof. For example, the machine-readable medium may include a Non-Volatile Random Access Memory (NVRAM), an Electrically Erasable Programmable Read-Only Memory (EEPROM), a storage drive, a NAND flash memory, and the like. Further, the machine-readable storage medium 620 can be computer-readable and non-transitory. Machine-readable storage medium 620 may be encoded with a series of executable instructions for managing processing elements.

The instructions 622, 624, 626, 628, when executed by processor 610 (e.g., via one processing element or multiple processing elements of the processor) can cause processor 610 to perform processes, for example, the processes depicted in FIGS. 1-4. Furthermore, computer 600 may be similar to system 500 and may have similar functionality and be used in similar ways, as described above.

Receiving instructions 622 can cause processor 610 to receive data regarding multiple social media profiles based on relevancy to a topic. The topic can include one or more keywords and can relate to a business context. Extraction instructions 624 can cause processor 610 to extract values from the data for a first, second, and third category of metrics for each profile. The first category of metrics can relate to messages associated with each social media profile. The second category of metrics can relate to attributes of each social media profile. The third category of metrics can relate to network relationships between each social media profile. The metrics may be similar to the metrics described previously with respect to method 100.

Weight assignment instructions 626 can cause processor 610 to apply a weight to each metric based on a categorical weight associated with each category of metrics and an individual weight associated with each metric within each category. Accordingly, a categorical weight can be applied to each of the first, second, and third category of metrics, each of the three categorical weights adding up to 100%. An individual weight may also be applied to each individual metric within the categories. Thus, a relative weight can be assigned to each general category indicating an overall value judgment on the importance of that category toward the influence score. The individual weights for each metric within the categories may thus be assigned relative to the other metrics within that category. Additionally, there can multiple categories at different levels. Overall, using categorical weights in addition to individual weights can provide an easier and more intuitive weighting assignment process than assigning a single weight to all of the metrics. This process may be implemented in methods 100 and 400 or system 500 as well. Similarly, the previously described weighting process can be applied to computer 600 instead of this one.

Scoring instructions 628 can cause processor 610 to determine an influence score for each profile based on calculating a weighted average of the values for each profile. The weighted average can be calculated based on the weights applied by weighed assignment instructions 626. For example, a weighted average can be determined for each category of metrics based on the individual weights on the individual metric values. The overall weighted average can then be determined by calculating a weighted average of the weighted averages of each category using the categorical weights. The influence score can thus be based on that overall weighted average. Alternatively, an overall weight for each individual metric can be determined used the respective categorical weight and individual weight, and the weighted average can be determined using the overall weight for each metric.

What is claimed is:

1. A method, comprising:
receiving data regarding a plurality of social media profiles based on relevancy to a keyword;
extracting, using a processor, values from the data for a first, second, and third category of metrics for each social media profile, the first category of metrics relating to messages associated with each social media profile, the second category of metrics relating to attributes of each social media profile, and the third category of metrics relating to network relationships between each social media profile;
assigning a weight to each metric; and
determining, using a processor, an influence score for each social media profile based on calculating a weighted average of the extracted values for each social media profile.

2. The method of claim 1, further comprising:
receiving the keyword from a user interface; and
providing the keyword to a social media monitoring engine,
wherein the data regarding the plurality of social media profiles is received from the social media monitoring engine.

3. The method of claim 1, wherein the keyword relates to a business context and the data is associated with a time period.

4. The method of claim 1, wherein the first category of metrics measures, for a given social media profile, an amount of engagement gained, an amount of engagement done, an amount of on-topic activity, an amount of on-topic reach, and content value.

5. The method of claim 1, wherein the second category of metrics measures, for a given social media profile, a number of followers, a number of profiles being followed, and a number of updates.

6. The method of claim 1, wherein the third category of metrics measures, for a given social media profile, a number of profiles connected solely through the given social media profile, an average geodesic distance to other profiles, and a level of popularity of profiles to which the given social media profile is directly connected.

7. The method of claim 1, further comprising normalizing each extracted value of each metric based on the following formula:
$$\frac{( Value - Min )}{MaxCutoff - Min} * 10 ,$$
wherein Value is an extracted value for a given metric for a given social media profile, Min is a minimum extracted value for the given metric based on all of the social media profiles, and MaxCutoff is a value in the 98^{th} percentile for the given metric based on all of the social media profiles.

8. The method of claim 1, wherein the weight for a metric is configurable via a user interface.

9. The method of claim 1, wherein the weight for a metric is determined using Structural Equation Modeling.

10. A system, comprising:
an interface to initiate a search of twitter profiles based on a keyword and a time period;
a communication interface to receive a list of twitter profiles and associated data relevant to the keyword and the time period;
a metric extractor to identify values of content metrics, profile metrics, and network metrics for each twitter profile in the list of twitter profiles;
a normalizer to normalize the values of the content metrics, profile metrics, and network metrics; and
a score determiner to determine an influence score for each twitter profile based on calculating a weighted average of the normalized values associated with each twitter profile.

11. The system of claim 10, wherein the system is configured to store weights associated with the content metrics, profile metrics, and network metrics, and wherein the score determiner is configured to use the stored weights to calculate the weighted average of the normalized values.

12. The system of claim 10, wherein the content metrics measure, for a given twitter profile, an amount of engagement gained, an amount of engagement done, an amount of on-topic activity, an amount of on-topic reach, and content value.

13. The system of claim 10, wherein the profile metrics measure, for a given twitter profile, a number of followers, a number of profiles being followed, and a number of updates.

14. The system of claim 10, wherein the network metrics measure, for a given twitter profile, a number of profiles connected solely through the given twitter profile, an average geodesic distance to other profiles, and a level of popularity of profiles to which the given twitter profile is directly connected.

15. A non-transitory machine-readable storage medium encoded with instructions executable by a processor, the machine-readable medium comprising:
instructions to receive data regarding multiple social media profiles based on relevancy to a topic;
instructions to extract values from the data for a first, second, and third category of metrics for each social media profile, the first category of metrics relating to messages associated with each social media profile, the second category of metrics relating to attributes of each social media profile, and the third category of metrics relating to network relationships between each social media profile;
instructions to apply a weight to each metric based on a categorical weight associated with each category of metrics and an individual weight associated with each metric within each category; and
instructions to determine an influence score for each social media profile based on calculating a weighted average of the values for each social media profile.
